(19) United States
(12) Patent Application Publication
(10) Pub. No.: US 2014/0114733 A1
(43) Pub. Date: Apr. 24, 2014

(54) Business Review Internet Posting System Using Customer Survey Response

(71) Applicant: Thomas A Mello, Scottsdale, AZ (US)

(72) Inventor: Thomas A Mello, Scottsdale, AZ (US)

(21) Appl. No.: 14/061,636

(22) Filed: Oct. 23, 2013

Related U.S. Application Data
(60) Provisional application No. 61/717,498, filed on Oct. 23, 2012.

(51) Int. Cl. G06Q 30/02

(52) U.S. Cl. CPC G06Q 30/0282; G06Q 30/0217
USPC 705/14.19

(57) ABSTRACT

A survey is presented to a customer who has recently used the services (or products) of a business The customer responses to the survey then, in turn, are used to create an average rating and a short two to five sentence paragraph describing the customer experience. The sentences are based on how they respond to survey questions, and are presented to the customer for verification/editing before the customer is asked to post the comment online. The customer's email is requested and used as part of the posting process.

### CROSS REFERENCE TO RELATED APPLICATIONS

This application claims the benefit of U.S. Provisional Application No. 61/717,498 filed on Oct. 23, 2012. The entire provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is related to customer satisfaction surveys, in particular, surveys that are done on a mobile platform, via phone text messaging and by a link to a website where a survey is hosted.

(2) Description of Related Art

US publication no. 2008/0214216 discloses a Mobile Notification System where a customer is provided with information related to a business on a mobile phone. For example, this idea is useful for notifying a customer about information related to a current hair styling appointment such as wait time status, and notifies the customer when the stylist will be available. This allows the customer to engage in other activities such as shopping/reading/work/errands, etc. without fear of missing a time slot. The application also describes a provision for providing the customer a discount or small gift for taking part in a marketing survey. However, no teaching is included for providing a method whereby a customer is enticed to conveniently participate in a survey related to their experience with the business and conveniently posting it online.

Other art methods such as US publication no. 2006/0257839 teach sending a survey to a mobile phone capable of data transmission and reception over a communications network. This allows convenient and clear communication among survey choices and sending them back in reply. However, no mention is made whereby the user's personal experience is posted or shared with the general public.

Many businesses operate with customers who use their services without taking the additional effort to share their experience (good or bad) with the general public. Certain internet companies are places where users share/post their business reviews online, and the average review is frequently found in internet searches where it is presented to internet users who are looking for a particular business (such as shopping or a restaurant). Such reviews are often 3.4 out of 5 stars for example. Some internet users have habits of typing up reviews and sharing them, and this can create bias for a small business when the number of reviews are very small. The bias may be good or bad for a business. Also it can be a disadvantage to a business to have fewer reviews as it gives the impression that fewer people visit the business when compared to other businesses that have many reviews.

To strengthen the review process and increase the number of reviews, there is need in the art to have a convenient method whereby an increase in the amount of business reviews can be conveniently created and posted, without loss of integrity in the reviewing system.

### BRIEF SUMMARY OF THE INVENTION

The present invention is a system whereby a customer is texted an offer via a small gift or other incentive, such as a chance to win a gift in a drawing or a point system, to participate in a simple survey related to their experience with the business. The survey is presented to a customer who has recently completed/used the services or products of a business. They answer questions in simple selections, such as yes/no, rating from 1-5, selection between discrete choices a, b, c, & d, etc., and their input is, in turn, received by the survey database. Their responses, in turn, are then interpreted by a program into an English language as a review and presented back to the customer as an online review for them to edit and make changes. After the customer makes any changes, the customer is then asked whether they would like to post their review online. If the customer agrees, their review is then posted online.

### BRIEF DESCRIPTION OF THE SEVERAL VIEWS OF THE DRAWING(S)

FIG. 1 shows the method of communication where the customer is contacted about a survey and how it is turned into an online review.

FIG. 2 shows the communication flow of how the customer is contacted for a survey, and includes an employee at a business, the phone company network, and a third party remote site.

FIG. 3 shows a control overview of how the sentence generation program works.

### DETAILED DESCRIPTION OF THE INVENTION

One goal of the present invention is to provide a convenient, efficient method whereby an online business review can proceed with convenience to the customer of a business.

Another goal is to provide feedback to the business where they can receive timely information related to their services/products and know how they are doing. The information can be tailored down to individual servers and they can identify employees that need additional training, receive rewards, or possible corrective action such as personal instruction, coaching or re-assignment.

Another goal is to provide an enticement for customers to actually provide feedback and still fall within guidelines that are acceptable for reviews. The can be reward points, joining a mailing list, notifications about future deals, discounts, coupons, business reward point memberships, priority seating, etc.

Another goal is to generate the review for the customer.

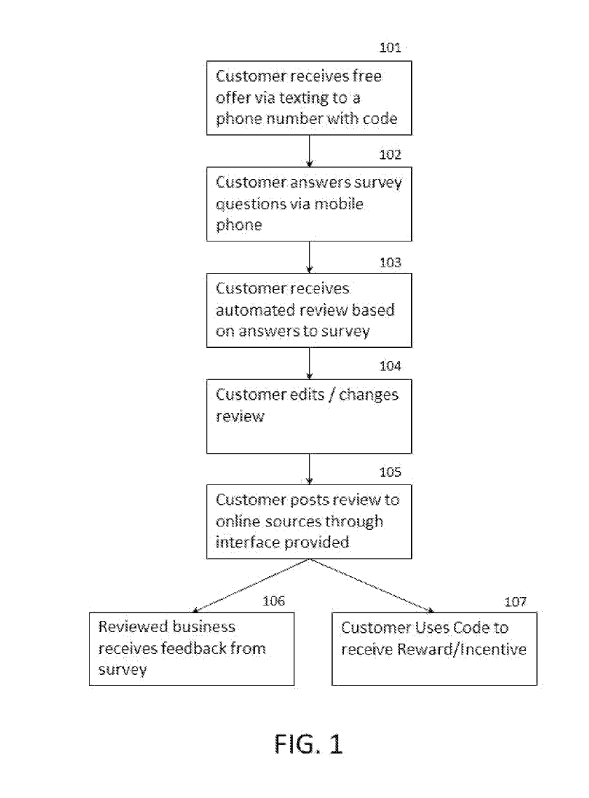

To these ends, FIG. 1 shows the method where a Customer receives free offer via texting to their phone number including a code 101. The code is important for the incentive/reward, but also is an index for information related to the sale of products and will be associated with any employees who served the customer. The customer then answers the survey questions via mobile phone 102 and then receives an automated written paragraph review based on answers to the survey 103. The customer is then offered the chance to edit or change the review suitable to the customer's liking 104. Finally, the review is posted on behalf of the customer 105 with their agreement. A valid email address is needed for the survey to be posted.

The business that is reviewed in the survey receives valuable feedback from the survey 106 and the customer receives the incentive/reward 107 based on the original enticement offer.

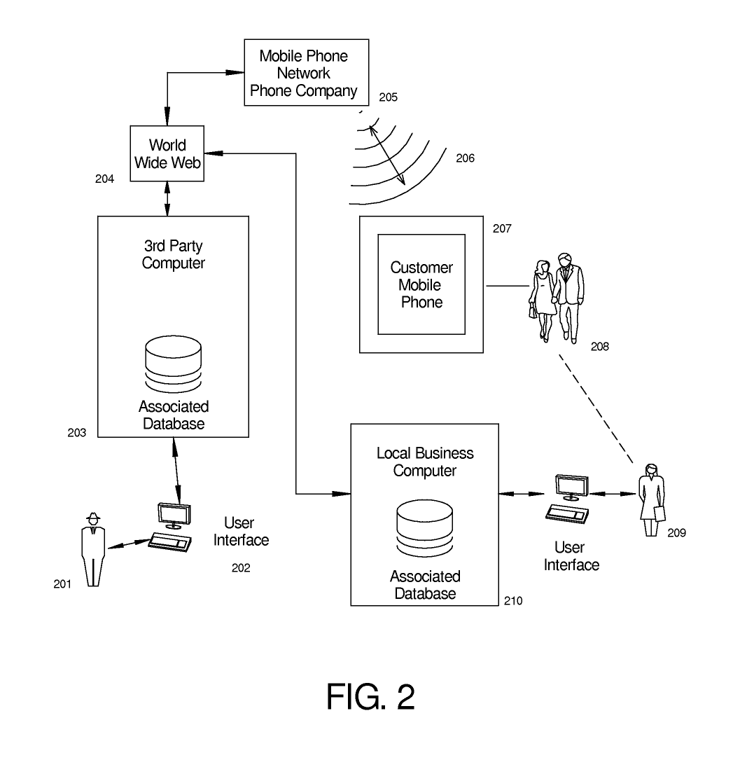

In FIG. 2, an administrator 201 via a user interface 202 maintains a third party computer and associated database 203 that generates the surveys for clients who use the service. The clients would be local business who participate in the survey program. The third party computer accesses the world wide web 204 and contacts the local business computer and associated database 210. When a local sales person 209 works with a customer 208 and makes a sale, the salesperson enters sales data into the local business computer 210, the customer/sale information is sent to the third party computer 203 which generates a survey. The survey is sent to the mobile phone company network 205 via the world wide web 204 which broadcasts 206 the survey to the customer's mobile phone 207.

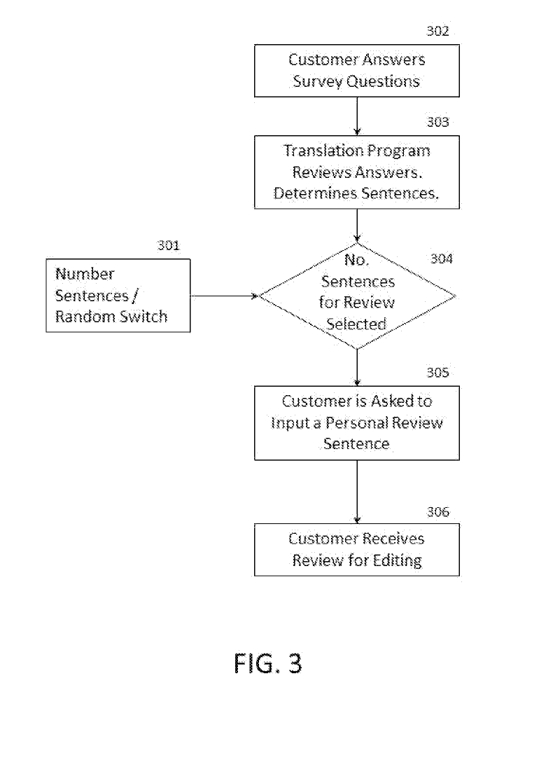

FIG. 3 shows an overview of how the sentence generation program is controlled. First, a program variable, or a switch is set 301 where the number of desired sentences is determined by the programmer. It can be a set number, for example, between two to five sentences. A random switch can also be employed to vary the number. Additionally, to generate the draft review, only particular survey questions can be used or they can be picked at random. Optionally, a combination of picked survey questions and random questions can be used. An example of this would be for a two sentence review to pick an overview experience survey question and a single random response from somewhere else in the survey.

The customer then answers the survey questions 302 which will vary by the type of business.

A translation program 303 designed to work with the survey will then use the answers to the survey questions and generate sentences for a draft review. The number of sentences to be presented to the customer is then selected 304 by the criterion already discussed. A final quality check is done by asking the customer to provide a personal review response/sentence 305 to ensure that the responses between different customers do not all sound the same. Finally, the customer receives the draft review for text editing 306. After editing, the customer is asked for ascent to post the review, and then it is posted to various internet websites based on default actions which the customer can also edit.

As is seen in FIG. 3, an important component of the present invention is the translation program which interfaces between the survey and the automatically generated review. The translation program is particularly adapted to work with responses to survey questions that are discrete, that is, numeric or letters, or a choice between limited alternatives. That would be a choice from a selection of a, b, c, or d, -or- True or False, -or- rating from 1 to 5, -or- Yes or No.

In an embodiment of the invention, each discrete survey question response is associated with a number of words/phrases. For example, if the question is ‘How was your overall experience?’ And the customer is asked to rate it from 1 (poor) to 5 (excellent), the ratings from 1 to 5 can be associated with the following qualifiers for the written sentence:

Rating Qualifiers for #text1#
1 Lousy, frustrating, unacceptable, unworthy, poor, awful, unhappy, objectionable
2 inadequate, off-putting, insufficient, unlucky, unpleasant, ordinary
3 good, fine, decent, suitable, fitting, reasonable, moderately good, passable, nice
4 Great, well done, fully satisfying, impressive, notable, cool, lovely, charming, delightful, splendid, pleasing, agreeable
5 Excellent, wonderful, awesome, fantastic, amazing, impressive, magnificent, terrific, exquisite, superb, perfect, delightful, incredible, divine

If the review generator has the following experience sentence, it would use the qualifier this way:
I had a #text1# time/experience at the XXYY Restaurant.

The translator program would have any number of sentences in a database that could use the rating, and a random selection from a store of sentences could be used.
I left the XXYY restaurant with a #text1# feeling.
A #text1# time was had by all.
We didn't know what to expect at the XXYY Restaurant, but it turned out #text1#.

If the survey directly asks if the server was
1. very prompt
2. prompt
3. Slow
4. Inattentive

And the customer checks the box on 2. prompt, the translator program makes the following sentence:

‘The server I had was #text1#.’ becomes ‘The server I had was prompt.’

Based on the bill, the translator program can automatically determine if the review should be created in the first person (I), or in the third person (we). The review can include conjunctive words like, ‘however’ when transitioning from a bad comment to a good point. For example:
‘We had an unpleasant experience at the XXYY Restaurant. However, our server was very prompt.’

In this case, the words ‘We’, ‘unpleasant’, ‘However’, ‘our’, ‘very prompt’ were added by the translator program.

The translator program maintains a bank of suitable sentences in a database with place holders where the review responses can be inserted. An administrator will work with writers who will write suitable sentences that match the survey questions, and match words to the survey responses.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A method of creating an online review for a business comprising:
a) a customer who has received goods or services from said business,
b) sending a survey to a customer and an associated code, wherein said survey is sent to a mobile phone in the possession of said customer,
c) wherein an incentive is offered to said customer to complete said survey, wherein said associated code is additionally associated with said incentive,
d) wherein said survey contains defined choices for said customer,
e) wherein said customer completes said survey based on selecting from said defined choices for each survey question,
f) a personal review sentence is recorded by said customer,
g) wherein said survey responses are matched to English words,
h) wherein a plurality of review sentences are created which can make use of said English words,
i) wherein
i) a random or fixed number of said review sentences, and
ii) a said personal review sentence,
are selected for said online review,
j) wherein said online review is presented to said customer for editing, and
k) wherein said online review is posted online.
